(19) United States
(12) Patent Application Publication
(10) Pub. No.: US 2008/0158292 A1
(43) Pub. Date: Jul. 3, 2008

(54) PRINTHEAD WIPER HAVING A PLURALITY OF BLADES

(76) Inventor: Shr-How Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/951,306

(22) Filed: Dec. 5, 2007

(30) Foreign Application Priority Data
Dec. 29, 2006 (TW) 095149873

(51) Int. Cl. B41J 2/165

(52) U.S. Cl. 347/33

(57) ABSTRACT

A plurality of blades on a printhead wiper is used for wiping out the residual ink on the printheads having different length. The printhead wiper deforms when wiping out the residual ink on the printheads, allowing a first blade for wiping the long black print head and a second blade for wiping the short color print head. A disadvantage that the first blade having long length cannot completely cover and wipe the color printhead since the UV glue that fixes the color printhead withstands a portion of the first blade can be solved with the second blade having short length.

### BACKGROUND OF THE INVENTION

1. Field of the Invention

The present invention relates to a printhead wiper, and more specifically, to a printhead wiper having a plurality of blades.

2. Description of the Prior Art

The inkjet printing systems have been widely applied on various kinds of fax machine, printer, or sort of office facilities. To make sure the printhead of an inkjet printing system works normally, the inkjet printing system usually equips with a maintenance device for performing the basic cleaning on the printhead. A common maintenance device of an inkjet printing system in the marketplace cleans the printhead by wiping out the residual ink on the printhead through a deformable rubber wiper. In the U.S. Pat. No. 5,612,722, U.S. Pat. No. 5,997,128, and U.S. Pat. No. 6,527,362, several types of wipers are disclosed. FIG. 1 illustrates a normal rectangular wiper 10 for wiping out the residual ink 14 on a printhead 12. The wiper 10 stays in a position where it is not cleaning the printhead. The wiper 20 in FIG. 2 is usually applied on a maintenance device where the wiper moves perpendicular to the direction of the alignment of the printhead nozzles. The wiper 30 in FIG. 3 comprises two blades 32 of a same size at the tip of the wiper 30, which is equivalent to two equal blades and is generally applied on a maintenance device where the wiper moves in a same direction as the direction of the alignment of the printhead nozzles.

A color inkjet printer uses one black cartridge and one color cartridge wherein the black one is generally with longer length than that of the color one for faster printing speed and the easier-control feature of the black cartridge. Both the black and the color printheads stick on the cartridges with a UV glue at two ends of the printheads. Please refer to FIG. 4 and FIG. 5 wherein FIG. 4 is an illustration of a wiper 40 in the prior art cleaning a black printhead 50 on a black cartridge 50 and FIG. 5 is an illustration of the wiper 40 in the prior art cleaning a color printhead 62 on a color cartridge 60. Since the black printhead 52 is longer than the color printhead 62, the wiper 40 is capable of completely covering and cleaning the black printhead 52, where the UV glue 54 that fixes the black printhead 52 lies outside two ends of the wiper 40. But because the color printhead 62 is shorter than the black printhead 52, when the wiper 40 is cleaning the color printhead 52, the slightly protruding UV glue 64 at both ends of the color printhead 62 interferes with the wiper 40 and a gap between the wiper 40 and the color printhead 62 exists. This keeps the wiper 40 from completely covering and cleaning the residual ink on the color printhead 62. The prior art is trying to clean both the black and the color printheads by a time-consuming, also effort-consuming way that replacing the wipers with different length to do that. This can cause the maintenance device more likely to damage for changing the wipers 40 too often and it is also very inefficient. Other prior art maintenance device has two separate wipers with different lengths disposed at different locations for respectively cleaning the black and the color printheads. However, the size of the maintenance device increases therefore and so does the cost of manufacturing of the maintenance device.

### SUMMARY OF THE INVENTION

The present invention provides a printhead wiper having a plurality of blades. The printhead wiper comprises a body, a first blade protruding from the body, and a second blade protruding from the body substantially parallel to the first blade, the second blade having an indentation.

The present invention also provides a printhead wiper having a plurality of blades. The printhead wiper comprises a body, a first blade protruding from the body, and a second blade protruding from the body substantially parallel to the first blade, the length of the second blade shorter than the length of the first blade.

The present invention also provides an inkjet device. The inkjet device comprises a housing, a first printhead disposed in the housing, a second printhead disposed in the housing, the length of the first printhead being longer than the length of the second printhead and an UV glue disposed at one end of the second printhead, and a printhead wiper disposed in the housing for wiping the residue ink of the first printhead and the second printhead when the first printhead and the second printhead move relatively to the printhead wiper. The printhead wiper comprises a body, a first blade protruding from the body having a length substantially equal to the length of the first printhead, and a second blade protruding from the body substantially parallel to the first blade, the second blade having an indentation larger than the UV glue on the second printhead.

The present invention also provides an inkjet device. The inkjet device comprises a housing, a first printhead disposed in the housing, a second printhead disposed in the housing, the length of the first printhead being longer than the length of the second printhead, and a printhead wiper disposed in the housing for wiping the residue ink of the first printhead and the second printhead when the first printhead and the second printhead move relatively to the printhead wiper. The printhead wiper comprises a body, a first blade protruding from the body whose length is substantially equal to the length of the first printhead, and a second blade protruding from the body substantially parallel to the first blade, the length of the second blade being substantially equal to the length of the second printhead.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a first type of wiper in the prior art.

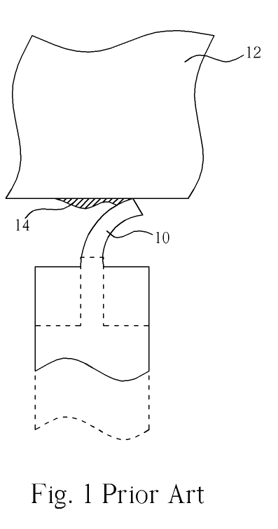

FIG. 2 is an illustration of a second type of wiper in the prior art.

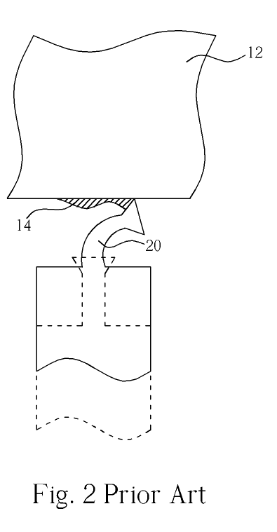

FIG. 3 is an illustration of a third type of wiper in the prior art.

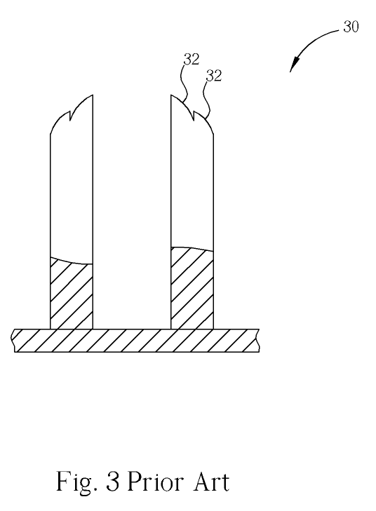

FIG. 4 is an illustration of a wiper in the prior art cleaning a black printhead.

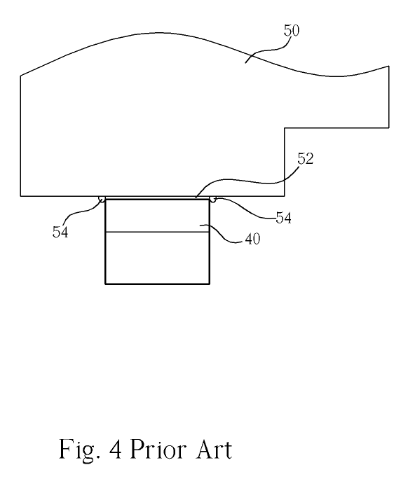

FIG. 5 is an illustration of a wiper in the prior art cleaning a color printhead.

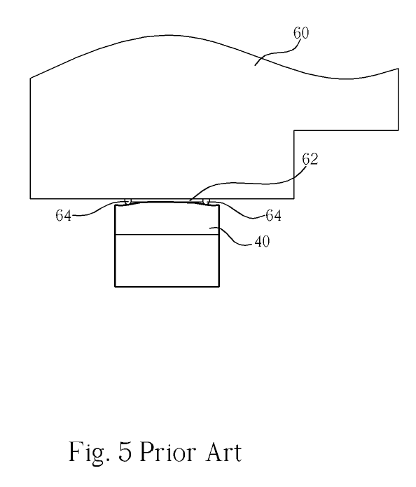

FIG. 6 is an illustration of a first exemplary embodiment of a printhead wiper having a plurality of blades according to the present invention.

FIG. 7 is an illustration of a second exemplary embodiment of a printhead wiper having a plurality of blades according to the present invention.

FIG. 8 is an illustration of applying the printhead wiper having a plurality of blades of the present invention for wiping the printhead.

FIG. 9 is an illustration of the relative position of the two blades of the printhead wiper and the black cartridge and the color cartridge of the first exemplary embodiment.

FIG. 10 is an illustration of the relative position of the two blades of the printhead wiper and the black cartridge and the color cartridge of the second exemplary embodiment.

FIG. 11 is an illustration of an inkjet device according to the present invention.

### DETAILED DESCRIPTION

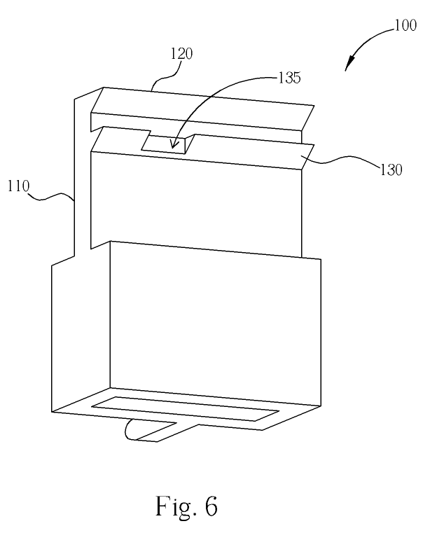

FIG. 6 is an illustration of first exemplary embodiment of a printhead wiper 100 having a plurality of blades according to the present invention. The printhead wiper 100 comprises a body 110, a first blade 120, and a second blade 130. The first blade 120 and the second blade 130 are substantially parallel to each other and protrude from the body 110 in a same direction. The second blade 130 further comprises an indentation 135. Although the first blade 120 and the second blade 130 have a triangular cross-section, other forms of cross-section are also available for applying in the present invention as long as the blades are capable of wiping out the residual ink on the printhead.

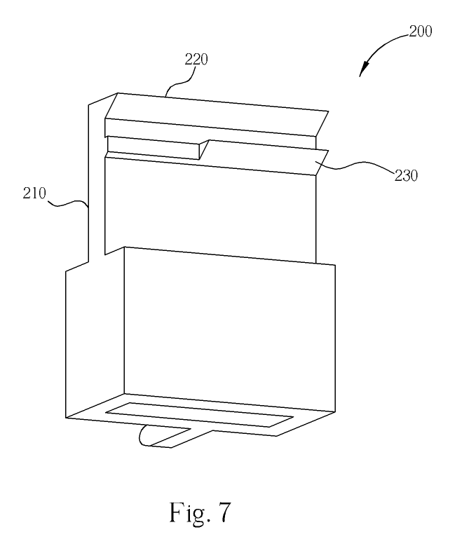

FIG. 7 is an illustration of second exemplary embodiment according to the present invention. The printhead wiper 200 comprises a body 210, a first blade 220, and a second blade 230. The length of the second blade 230 is shorter than the length of the first blade 220. Although the first blade 220 and the second blade 230 have a triangular cross-section, other forms of cross-section are also available for applying in the present invention as long as the blades are capable of wiping out the residual ink on the printhead.

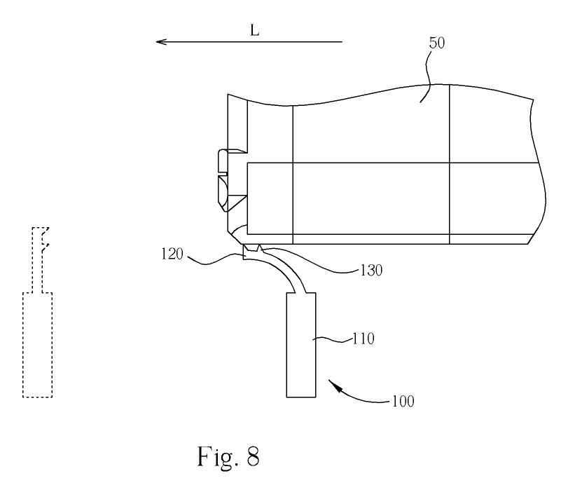

Please refer to FIG. 8. FIG. 8 is an illustration of applying the printhead wiper 100 having a plurality of blades of the present invention for wiping the printhead. The printhead wiper 100 in the dashed line represents the location when the printhead wiper 100 is not cleaning the printhead. The first blade 120 is disposed in an inkjet device slightly higher than the printhead, but the second blade 130 can be either higher or lower than the printhead. When the cartridge contacts the first blade 120 and deforms the body 110, the second blade 130 can reach the printhead, and due to the assembly tolerance of each element in the inkjet device, the present invention can also manage to dispose both the first blade 120 and the second blade 130 higher than the printhead, assuring the second blade 130 for contacting the printhead when the body 110 deforms. When the printhead wiper 100 performs cleaning to the black cartridge 50 (the black cartridge 50 moves to the direction L), the interference by the black cartridge 50 to the printhead wiper 100 deforms the printhead wiper 100, which therefore puts the first blade 120 and the second blade 130 to push against the printhead of the black cartridge 50. As the black cartridge 50 keeps moving in the direction L, relative to the first blade 120 and the second blade 130, the first blade 120 and the second blade 130 of the printhead wiper 100 successively wipe through the printhead of the black cartridge 50 and wipe out the residual ink on the printhead. Since the first blade 120 and the second blade 130 of the printhead wiper 100 have a length substantially equal to that of the black printhead, the blades can completely cover the black printhead and wipe out the residual ink on it. It is similar with the process as the printhead wiper 100 cleans the color cartridge 60, but since the printhead on the color cartridge 60 is shorter than the printhead on the black cartridge 50, the second blade 130 of the printhead wiper 100 is capable of sufficiently doing the job to clean the residual ink on the color printhead.

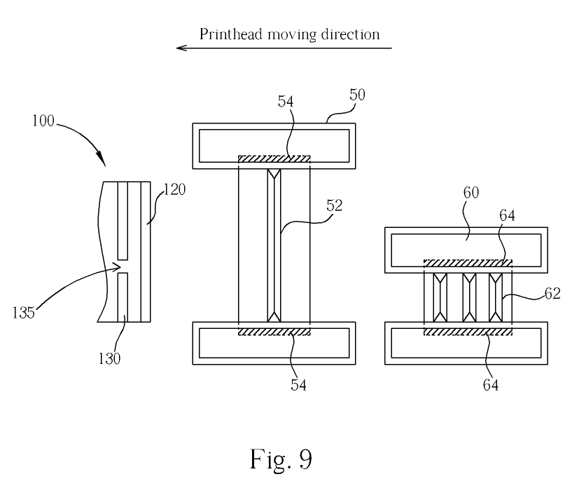

Please refer to FIG. 9. FIG. 9 is an illustration of the relative position of the two blades 120,130 of the printhead wiper 100 and the black cartridge 50 and the color cartridge 60 of the first exemplary embodiment. The first blade 120 protrudes from the body 110 closer to the printheads 52,62 than the second blade 130 does. Hence, when the printhead wiper 100 cleans the printheads 52,62, the cartridges 50, 60 deform the first blade 120 first then the second blade 130 so that both the first blade 120 and the second blade 130 can contact the printheads 52,62. During the cleaning process and after the printhead 100 finishes cleaning the black printhead 52 and goes forward to clean the color printhead 62, a gap exists between the first blade 120 and the color printhead 62 because the UV glue 64, the protrusion on the printhead, on the color printhead 62 withstands the first blade 120 and disables the first blade 120 from completely covering and wiping out the residual ink on the color printhead 62. And then the second blade 130 wipes through the color printhead 62. The unique indentation 135 disposed on the second blade 130 of the printhead wiper 100 of the present invention allows the UV glue 64 of the color cartridge 50 to pass through and therefore the UV glue 64 does not withstand the second blade 130, in which the second blade 130 is capable of completely covering the color printhead 62 and wiping out the residual ink on the color printhead 62.

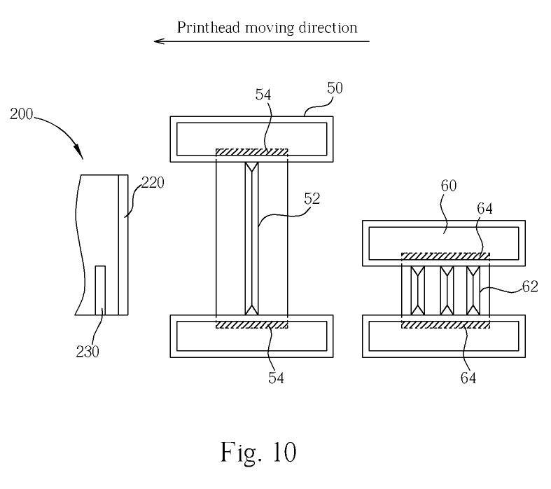

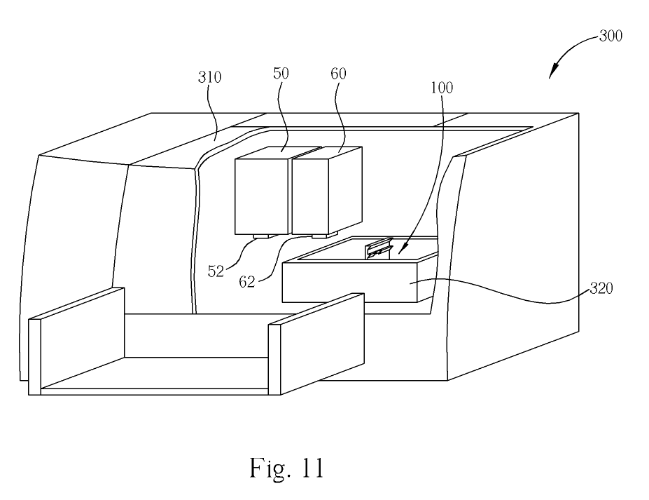

Additionally, in a second exemplary embodiment of the present invention, the length of the second blade 230 of the printhead wiper 200 is shorter than that of the first blade 220 and is substantially equal to the length of the color printhead 62. Consequently, for the printhead wiper 200 to clean the printheads, the first blade 220 is capable of completely covering the black printhead 52 while the second blade 230 is capable of completely covering the color printhead 62. An illustration of the relative position between the printhead wiper 200 and the cartridges is shown in FIG. 10. FIG. 11 refers to an exemplary embodiment of an inkjet device 300 with the printhead wiper 100 or 200 according to the present invention. The black printhead 52 and the color printhead 62 are disposed on the black cartridge 50 and the color cartridge 60 in the housing 310 of the inkjet device 300 respectively and the printhead wiper 100 or 200 is disposed on a maintenance device 320 inside one side of the inkjet device 300. When the inkjet device 300 drives its black printhead 52 along with the color printhead 62 to its one side, the printhead wiper 100 (200) performs the cleaning aforementioned, i.e. the first blade 120 (220) and the second blade 130 (230) disposed on the printhead wiper 100 (200) clean the black printhead 52 and the color printhead 62 respectively.

In both the first and second exemplary embodiments of the present invention, the relative positions of the first blades 120,220 and the second blades 130,230 are exchangeable, i.e. the first blades 120,220 can protrude from the body 110,210 closer to the printhead 52,62 than the second blades 130,230 do, or vice versa.

Different from any of the prior art printhead wipers, the present invention utilizes the plurality of blades on the printhead wiper for wiping out the residual ink on the printheads having different length. The printhead wiper deforms when wiping out the residual ink on the printheads, allowing a first blade, substantially in equal length with the black printhead, for wiping the long black printhead and a second blade, substantially in equal length with the color printhead or with the black printhead but having an indentation allowing for the UV glue on the color printhead to pass through, for wiping the short color printhead. The disadvantage that the first blade having long length cannot completely cover and wipe the color printhead since the UV glue that fixes the color printhead withstands a portion of the first blade can be solved with the second blade having short length.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A printhead wiper having a plurality of blades, comprising:
a body;
a first blade protruding from the body; and
a second blade protruding from the body substantially parallel to the first blade, the second blade having an indentation.

2. The printhead wiper of claim 1, for wiping the residue ink of a first printhead and a second printhead, the length of the first printhead being longer than the length of the second printhead, a protrusion disposed at one end of the second printhead, wherein the lengths of the first blade and the second blade are substantially equal to the length of the first printhead and the indentation is larger than the protrusion on the second printhead, the protrusion adaptive to pass through the indentation when the second printhead and the second blade move relatively to each other.

3. The printhead wiper of claim 1 wherein the first blade protrudes from the body in the same direction as the second blade protrudes from the body.

4. The printhead wiper of claim 1 wherein the cross-section of the first blade and the second blade is triangular.

5. The printhead wiper of claim 1 wherein the first blade is disposed on the body closer to a printhead than the second blade is disposed on the body and the first blade is higher than the printhead and when the printhead contacts the first blade and deforms the body, the second blade is capable of fully contacting the printhead.

6. A printhead wiper having a plurality of blades, comprising:
a body;
a first blade protruding from the body; and
a second blade protruding from the body substantially parallel to the first blade, the length of the second blade shorter than the length of the first blade.

7. The printhead wiper of claim 6, for wiping the residue ink of a first printhead and a second printhead, the length of the first printhead being longer than the length of the second printhead, wherein the length of the first blade is substantially equal to the length of the first printhead and the length of the second blade is substantially equal to the length of the second printhead.

8. The printhead wiper of claim 6 wherein the first blade protrudes from the body in the same direction as the second blade protrudes from the body.

9. The printhead wiper of claim 6 wherein the cross-section of the first blade and the second blade is triangular.

10. The printhead wiper of claim 6 wherein the first blade is disposed on the body closer to a printhead than the second blade is disposed on the body and the first blade is higher than the printhead and when the printhead contacts the first blade and deforms the body, the second blade is capable of fully contacting the printhead.

11. An inkjet device, comprising:
a housing;
a first printhead disposed in the housing;
a second printhead disposed in the housing, the length of the first printhead being longer than the length of the second printhead and a protrusion disposed at one end of the second printhead; and
a printhead wiper disposed in the housing for wiping the residue ink of the first printhead and the second printhead when the first printhead and the second printhead move relatively to the printhead wiper, the printhead wiper comprising:
a body;
a first blade protruding from the body having a length substantially equal to the length of the first printhead; and
a second blade protruding from the body substantially parallel to the first blade, the second blade having an indentation larger than the protrusion on the second printhead.

12. The inkjet device of claim 11 wherein the length of the second blade is substantially equal to the length of the first blade.

13. The inkjet device of claim 11 wherein the first blade protrudes from the body in the same direction as the second blade protrudes from the body.

14. The inkjet device of claim 11 wherein the cross-section of the first blade and the second blade is triangular.

15. The inkjet device of claim 11 wherein the first blade is disposed on the body closer to the first printhead and the second printhead than the second blade is disposed on the body and the first blade is higher than the first printhead and the second printhead and the second blade is capable of fully contacting the second printhead.

16. An inkjet device, comprising:
a housing;
a first printhead disposed in the housing;
a second printhead disposed in the housing, the length of the first printhead being longer than the length of the second printhead; and
a printhead wiper disposed in the housing for wiping the residue ink of the first printhead and the second printhead when the first printhead and the second printhead move relatively to the printhead wiper, the printhead wiper comprising:
a body;
a first blade protruding from the body, the length of the first blade being substantially equal to the length of the first printhead; and
a second blade protruding from the body substantially parallel to the first blade, the length of the second blade being substantially equal to the length of the second printhead.

17. The inkjet device of claim 16 wherein the first blade protrudes from the body in the same direction as the second blade protrudes from the body.

18. The inkjet device of claim 16 wherein the cross-section of the first blade and the second blade is triangular.

19. The inkjet device of claim 16 wherein the first blade is disposed on the body closer to the first printhead and the second printhead than the second blade is disposed on the body and the first blade is higher than the first printhead and the second blade is capable of fully contacting the second printhead.
